(19) United States
(12) Patent Application Publication
(10) Pub. No.: US 2002/0014259 A1
(43) Pub. Date: Feb. 7, 2002

(54) Method of and apparatus for removing brake and tire residues from a travel way

(75) Inventor: Josef Hahnl, Enns (AT)

Correspondence Address: THE FIRM OF KARL F ROSS, 5676 RIVERDALE AVENUE, PO BOX 900, RIVERDALE (BRONX), NY, 10471-0900, US

(73) Assignee: M-U-T Maschinen- Umwelttechnik- Transportanlagen Gesellschaft m.b.H.

(21) Appl. No.: 09/867,695

(22) Filed: May 30, 2001

(30) Foreign Application Priority Data
May 31, 2000 (AT) GM410/2000

(51) Int. Cl. B08B 7/04

(52) U.S. Cl. 134/26; 134/6; 15/320; 15/340.4

(57) ABSTRACT

The brake and rubber residues of runways, race ways and roadways are removed by rubbing a solvent onto the surface and then flushing the surface with water and vacuuming up the resulting mixture. The rotating rubbing sprayers and solvent spray and the water sprayer and suction head can be provided on one vehicle or on two vehicles as required.

### SPECIFICATION

### FIELD OF THE INVENTION

My present invention relates to a method of and to an apparatus for the removal of brake and tire residues from a travel way and, more particularly, to the removal of rubber traces from surfaces such as those of aircraft runways and race tracks.

### BACKGROUND OF THE INVENTION

The problem of rubber traces on traveled ways, such as aircraft runways, roadways and race tracks is far more often an aesthetic problem since brake residues and tire residues which form not only visually marred surfaces but reduces the surface adhesion and thus impede both traction and braking of vehicles subsequently traveling over the surfaces.

To remove such residues, machines have been provided heretofore with steel brushes which not only abrade the traces of rubber from the surface but tend to remove the surfaces of the runway, roadway or track themselves and any surfacing materials which may have been applied to such traveled ways. As a consequence the removal of the traces of rubber does not improve the appearance of the surface and even damages the surfaces to the extent that repaving may be required more often than is desired.

### OBJECTS OF THE INVENTION

It is, therefore, the principal object of the present invention to provide an improved method of and apparatus for the removal of brake and tire residues from such surfaces, referred to here as travelled ways, whereby the drawbacks of earlier techniques are avoided.

More specifically it is an object of the invention to provide a method of removing rubber residues from race tracks, runways and like surfaces which can effectively eliminate the black traces without reducing the traction properties of the surface and without so damaging the surface that frequent repaving is necessary.

Another object of the invention is to provide an apparatus or machine which is capable of removing the traces or rubber from such surfaces so that the surface itself remains intact.

### SUMMARY OF THE INVENTION

These objects and others which will become apparent hereinafter are attained, in accordance with the invention, in a method and with an apparatus which utilizes a solvent action to assist in the removal of the brake and tire residues, i.e. rubber traces, from such surfaces.

In method terms, the invention is a method of removing brake and tire residues from a travelled way which comprises the steps of:

(a) spraying a rubber solvent onto a strip of the traveled way from a sprayer on an advancing vehicle;

(b) rubbing the solvent onto a surface of the strip with rotating brushes located on the advancing vehicle behind the sprayer;

(c) thereafter displacing a water sprayer along the strip and spraying water onto the surface treated with the solvent and the brushes to form a mixture of water and solvent-dissolved and rubbed-off rubber; and

(d) subsequently evacuating the mixture from the surface.

In apparatus terms the invention makes use of one or more machines which can travel along the surface from which the rubber residues are to be removed and utilizes spray and suction devices and brushes which are capable of rubbing the traces on that surface. According to the invention, at least one vehicle is provided, especially a waste collection vehicle, which is provided at its front end with an attachment which includes a spray device for a rubber solvent and rotating brushes behind that spray device and which are capable of rubbing the solvent, sprayed upon the surface, onto that surface. Laterally offset from the spray device and the rubbing brushes on the same vehicle or on another vehicle, I provide another sprayer for water which is capable of spraying the water onto the strip parallel to the strip treated with the solvent and the brushes and after a duration sufficient to enable the solvent to dissolve rubber from the residues, the resulting mixture of water, solvent with dissolved rubber and rubbed-off rubber particles being drawn up by a suction head, behind the water sprayer and preferably behind the front and rear axles thereof.

The suction head may form part of a suction unit which can vacuum up the water mixture and dump it with the residues and remaining solvent in the waste receptacle of the first-mentioned vehicle or the vehicle provided with the water sprayer as the case may be.

With the system of the invention, rubbing of the rubber traces from the surface is accompanied by the solvent action previously mentioned, the brushes promoting intimate contact between the solvent and the residues on the surface. There is thus a chemical-mechanical action which results at least in part in a dissolution of the rubber and possibly also as facilitated removal of the rubber by the rubbing action so that in the subsequent step the dissolved rubber and any loosened rubber is diluted and suspended in the water and can be evacuated with the water. The application of the water is effected by a spraying unit on the front end of a vehicle and the vacuuming up of the water is effected at a suction head located rearwardly of the spray head.

The system of the invention can use a vehicle, especially a conventional rubbish or waste-collecting vehicle adapted to collect the slurry or sludge which results as described and which is provided with the units of the invention including the water spray and vacuum units.

The invention can be practiced, alternatively, by two vehicles which are displaced over the travelled way in a timed relationship, namely, a spray vehicle provided with the brush unit for rubbing the solvent into the residues and a waste-collection vehicle for collecting the tire residues.

When the system of the invention is mounted on only one vehicle, namely, a waste-collection vehicle, it has been found to be advantageous to provide the solvent sprayer and brush unit at a distance from the water spray and sludge collection unit and, preferably, with a spacing between them which can correspond to the width of the strips which are covered by the water and solvent sprays respectively, for example 70 cm. As a result, the solvent which is sprayed onto the treated strip and rubbed into the residues by the brushes are only contacted with the water and the slurry picked up on the next pass of the vehicle and thus after at least a predetermined residence time. The vehicle can treat strips of a width of say 70 cm in unit lengths, between passes of say 150 m and picks up the residues and mixture from the third solvent-treated strip from the strip to which the solvent is newly applied.

This ensures sufficient time for the solvent to pick and dissolve or loosen residues. The sludge or slurry can be disposed of by any conventional means, e.g. in a landfill or via a solvent-recovery system with treatment of the water as separated from the solvent.

The solvent spray and brush unit can be an attachment which is raisable and lowerable on the front end of the waste-collection truck and can be provided with at least one wheel capable of riding on the surface to be treated which holds the solvent-spray device and/or the brushes at an appropriate height for the treatment of the surface.

The brush unit may comprise two or more counter-rotating brush drums and upon wear of the bristles of the brush can be pressed downwardly toward the surface.

According to another feature of the invention, a blowing unit can be mounted on the truck behind the suction unit and can dispense compressed air and/or water to facilitate the pickup of the sludge or slurry. It has been found to be advantageous, moreover, for a heating unit to be provided for effecting a heat exchange with the rubber solvent and preferably also with the water to thereby raise the temperature of one or both of them.

The vehicle can be provided directly behind the driver's cabin with a tank for the rubber solvent and a diesel engine for the suction blower and for the solvent and water pumps and for any pumps necessary for the hydraulic control fluid or the compressed air which is used for control purposes. The suction blower may be mounted directly on or adjacent the diesel engine and the rear of the vehicle may be formed with a waste-collection receptacle below which the water reservoir can be provided. The suction blower can evacuate the waste collection vehicle through a filter unit and the waste vessel can be connected by a pipe or hose system with the suction head. The suction blower and the rubber-solvent pump and the water pump can also, if desired, be driven by hydraulic motors or a hydraulic motor which is indirectly driven by the diesel engine.

### BRIEF DESCRIPTION OF THE DRAWING

The above and other objects, features, and advantages will become more readily apparent from the following description, reference being made to the accompanying drawing in which:

FIG. 1 is a schematic side elevational view of a single vehicle system for the removal of brake and rubber-tire residues from a travelled way;

FIG. 2 is a diagrammatic plan view of this vehicle; and

FIG. 3 is a diagram showing the two-vehicle embodiment of the invention.

### SPECIFIC DESCRIPTION

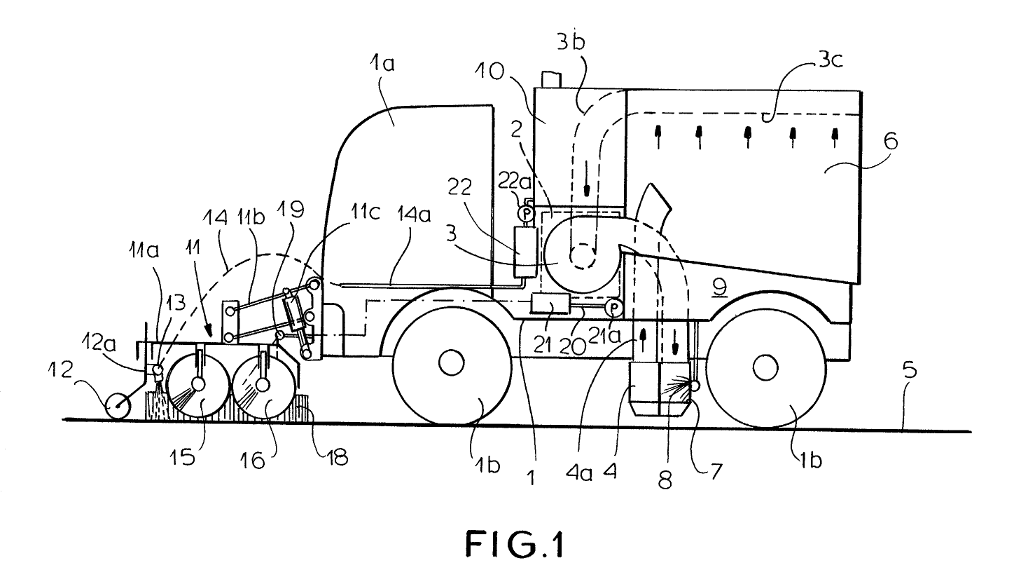

The vehicle shown in FIG. 1 is a modified waste-collecting vehicle akin to a rod sweeper and comprises the vehicle chassis 1 which is provided with a driver's cabin 1a and rearwardly thereof, a separate diesel engine 2 for a suction blower 3. A duct 3a connects the output side of that suction blower to a blowing head 7 which is adjacent but behind a suction head 4 which vacuums up the mixture according to the invention.

The vehicle wheels support the chassis 1 and are represented at 1b and the suction blower 3 has an intake duct 3b opening into the waste-collection chamber 6 via a filter unit which has been represented at 3c. The residues from a strip 5 of the runway, raceway or roadway are thus drawn upwardly by the suction head 4 via the duct 4a into the container 6.

The blowing head 7 can be provided with a spray unit 8 for jets of water which help lift the slurry or mixture from the surface 5 into the head 4. The spray is fed by a pump (not shown) connected to the diesel engine and drawing water from a water tank 9 forming the bottom of the vessel 6. The apparatus is also provided, behind the cabin 1a, with a tank 10 for a rubber solvent, namely, an oil-like liquid.

At the front of the vehicle there is provided a hydraulically raisable and lowerable attachment 11 with one or more riding wheels 12 controlling the height of counter-rotating brushes 15 and 16. The attachment comprises a frame 11a connected to the parallelogrammatic linkage 11b and controlled by the hydraulic cylinder 11c. The cylinders 12 regulate the height of frame 12a carrying the spray nozzles so that the sprayer 13 rides at a constant height of the surface 5. The sprayer 13 is connected by a hose 14 and duct work represented at 14a with a pump 22 which can be driven by the diesel engine and is supplied from the tank 10 with the rubber solvent. The spray nozzles are directed against the surface of the traveled way.

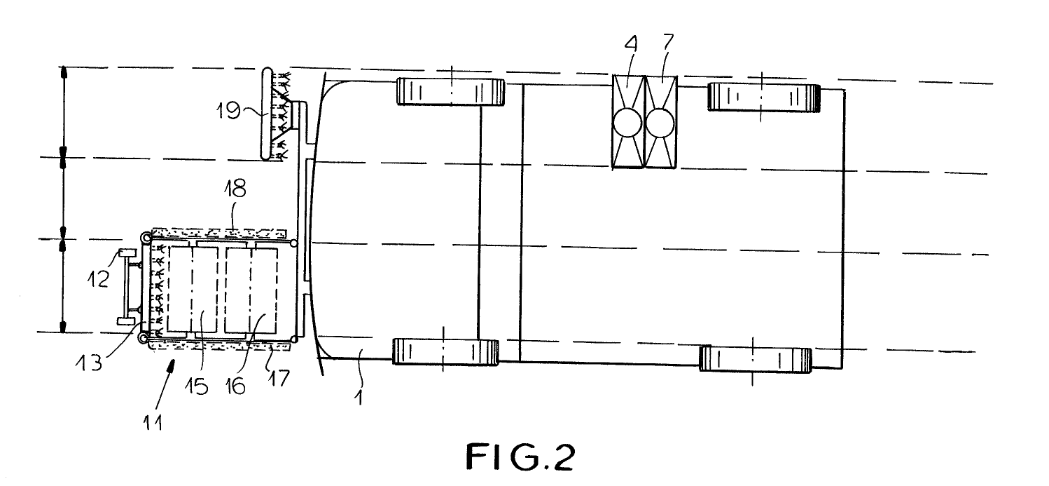

The brushes 15 rotate in opposite senses and are flanked by lateral brushes 17, 18 which can be stationary (FIG. 2). The brushes 15 and 16 can be height-adjustable and can rest with their own weights against the surface 5. The brushes can have synthetic resin filament bristles or bristles of mixed composition.

FIG. 2 shows that the front of the vehicle is divided into three parts and an attachment 11 extends over the first third of the width of the vehicle while the spray head 19 extends over another third of the width of the vehicle while these two parts are spaced apart by the middle third of the vehicle. The vehicle is designed to treat strips of the traveled way with the width of say 70 cm and a length of about 150 m in each pass.

As shown in FIG. 2, the upper strip has previously been provided on the previous pass of the vehicle from right to left with the rubber solvent and the rubbing action utilizing the attachment 11. The pass illustrated in FIG. 2 removes the solvent and residue mixture by diluting or flushing it with water from the spray device 19.

From FIGS. 1 and 2 it will be apparent that the spray device 19 can be supplied with water via line 20 and a pump 21a from the tank 9. That pump may be driven directly or indirectly by the diesel engine 2. In the line 10 a heat exchanger 21 can be provided to heat water delivered to the spray head 19. Another heat exchanger 22 can be provided in the line 14a running to the solvent sprayer 13 to heat the solvent. Both the solvent and the water can be heated to temperatures in the range of 40 to 60° C. The heat exchanger 22 is thus located between the solvent tank 10 and the sprayer 13.

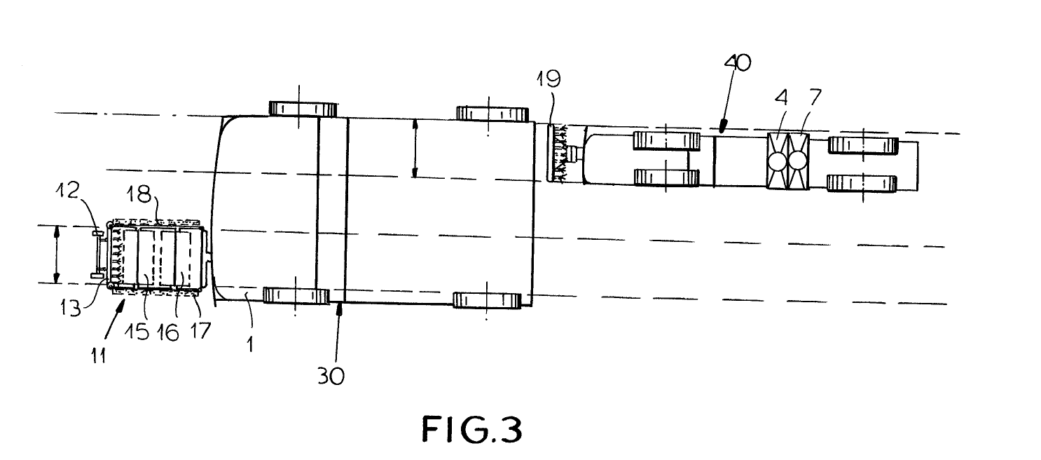

The hot water sprayed from the sprayer 19 onto the upper strip (FIG. 2) dilutes and flushes the solution of solvent and rubber from the surface 5 and the resulting slurry is picked up by the suction head 4 which is directly in line with the sprayer 19 and extends over the third of the width of the vehicle like that sprayer. The blower head 7 facilitates the pickup of the slurry. The slurry is deposited in the receptacle 6 of the vehicle of FIGS. 1 and 2 or a second vehicle as will be described in connection with FIG. 3.

As much as possible the tires of the vehicle should be located outside the strip subjected to the action of the solvent or should be composed of a rubber resistant to the solvent action. In FIG. 2, the wheels of the vehicle are either located along the strip flushed with water or outside the limits of the strip subjected to the solvent. In the return pass of the vehicle, the center strip shown in FIG. 2 is treated with the solvent and the rubbing action and that strip is flushed with water in a subsequent pass of the vehicle from left to right.

From FIG. 3 it will be apparent that two vehicles 30 and 40 are provided, the vehicle 30 being equipped to apply the solvent to a strip of the travelled way and to rub that solvent into the surface in the manner which has been described. The spray head 19, however, is mounted on the second vehicle 40 which also has the suction head 4 and the blower head 7 as have been described. Each vehicle may extend over a number of strip widths as shown for the vehicle 30 or may be of a width corresponding to a strip width as shown for the vehicle 40 in FIG. 3.

I claim:

1. A method of removing brake and tire residues from a traveled way, comprising the steps of:
(a) spraying a rubber solvent onto a strip of the traveled way from a sprayer on an advancing vehicle;
(b) rubbing said solvent onto a surface of said strip with rotating brushes located on said advancing vehicle behind said sprayer;
(c) thereafter displacing a water sprayer along said strip and spraying water onto the surface treated with said solvent and said brushes to form a mixture of water and solvent-dissolved and rubbed-off rubber; and
(d) subsequently evacuating said mixture from said surface.

2. The method defined in claim 1 wherein said water sprayer sprays water onto a strip of said surface parallel to the strip being treated with said solvent and rubbed by said brushes and previously treated with said solvent and rubbed by said brushes in a prior pass of said vehicle.

3. The method defined in claim 2 wherein said strips are separated by a further strip of said surface treated with said solvent and rubbed by said brushes and along which the solvent has a residence time in contact with said residues enabling solubilization of rubber of said residues in said solvent.

4. The method defined in claim 1 wherein said water sprayer and a suction head are carried by another vehicle and are displaced over said strip subsequent to the advance of the first-mentioned vehicle thereover.

5. The method defined in claim 1 wherein said strip has a width of about 70 cm.

6. An apparatus for removing brake and tire residues from a traveled way comprising at least one vehicle capable of advancing along a strip of the traveled way;
a solvent sprayer on said vehicle behind said solvent sprayer for spraying a rubber solvent onto said strip of the traveled way;
rotating brushes on said vehicle for rubbing said solvent onto a surface of said strip;
a water sprayer displaceable along said strip for spraying water onto the surface treated with solvent and said brushes to form a mixture of water and solvent-dissolved and rubbed-off rubber; and
a suction head behind said water sprayer for evacuating said mixture from said surface.

7. The apparatus defined in claim 6 wherein said vehicle is a waste-collection vehicle.

8. The apparatus defined in claim 6 wherein said water sprayer is displaced with a lateral offset from said solvent sprayer and said brushes along said surface.

9. The apparatus defined in claim 6 wherein said suction head and said water sprayer are mounted on a vehicle, said suction head being located between said front and rear axles of a vehicle on which said water sprayer and spray head are mounted.

10. The apparatus defined in claim 6 wherein said vehicle on which said water sprayer and suction head are mounted is a waste-collection vehicle having a receptacle receiving said mixture.

11. The apparatus defined in claim 6 wherein said water sprayer and said solvent sprayer and said brushes are mounted at the front of a single vehicle and said water sprayer is offset by at least a width of said strip from said solvent sprayer and said brushes.

12. The apparatus defined in claim 11 wherein said width is substantially 70 cm.

13. The apparatus defined in claim 11 wherein said water sprayer is spaced from said solvent sprayer and said brushes by a gap of a width at least equal to the width of said strip.

14. The apparatus defined in claim 11 wherein said brushes are counter-rotating brushes.

15. The apparatus defined in claim 11 wherein said brushes and said solvent sprayer are provided on at least one support capable of vertical displacement relative to said vehicle.

16. The apparatus defined in claim 15, further comprising means for displacing said brushes toward said surface upon wear of said brushes.

17. The apparatus defined in claim 11, further comprising a heating device connected with at least one of said spreaders for heating a liquid dispensed thereby.

18. The apparatus defined in claim 11 wherein said brushes and said solvent sprayer are provided on an attachment mounted at a front of said vehicle, said vehicle having an operator cabin and behind said cabin a diesel engine for driving at least a suction pump connected to said suction head.

19. The apparatus defined in claim 11, further comprising a blowing head behind said suction head for blowing against said surface.

20. The apparatus defined in claim 11 wherein said water sprayer extends substantially a full width of said vehicle on which said water sprayer is mounted.
